(19) United States
(12) Patent Application Publication
(10) Pub. No.: US 2003/0191611 A1
(43) Pub. Date: Oct. 9, 2003

(54) Behavioral circuit modeling for geometric programming

(76) Inventors: Maria del Mar Hershenson, Palo Alto, CA (US); Dave Colleran, San Mateo, CA (US); Arash Hassibi, Mountain View, CA (US)

Correspondence Address: Edwin H. Taylor, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/118,221

(22) Filed: Apr. 5, 2002

(51) Int. Cl. G06F 17/10

(52) U.S. Cl. 703/2

(57) ABSTRACT

A method for providing a mathematical expression in the form of a posynomial or max-monomial function for a performance metric of an integrated circuit is disclosed. Data representing a plurality of circuit variables is provided and curve fitting occurs to selected ones of the variables. A plurality of expressions may be used and when used, error at the transition from one expression to another is checked. The resultant expressions lend themselves to a global solution with design problems expressed as geometric programs.

### BACKGROUND OF THE DISCLOSURE

1. Field of the Invention

The invention relates to the field of modeling behavior of integrated circuits.

2. Prior Art

There is a growing need to provide optimal designs for integrated circuits particularly as the critical dimensions decrease and speed of such circuits increase.

A relatively recent development in mathematics has provided an improved computerated tool for designing integrated circuits using geometric programs. In general, an operating model is developed in the form of a posynomial function. The geometric program once in the form of a convex program can be solved with efficient interior-point methods. The most important feature of geometric programs is that they can be globally solved with great efficiency. The algorithm determines whether the problem is infeasible (i.e., no design can meet all constraints). Also, the starting point of an optimization algorithm does not have any affect on the solution.

One interior-point method is described by K. O. Kortanek, X. Xu, and Y. Ye, “An Infeasible Interior-point Algorithm for Solving Primal and Dual Geometric Programs,” Math Programming, 76:155-181, 1996. This method has the desirable feature of exploiting sparsity in the problem, (i.e., efficiently handling problems in which each variable appears in only a few constraints). Additional methods of solving geometric programs are described in: Y. Nesterov and A. Nemirovsky, “Interior-Point Polynomial Methods in Convex Programming,” Volume 13 of Studies in Applied Mathematics, SIAM, Philadelphia, Pa., 1994; and A. Fiacco and G. McCormick, Nonlinear Programming: Sequential Unconstrained Minimization Technologies, Wiley 1968 (Reprinted in SIAM Classics in Applied Mathematics series 1990).

The present invention is directed towards obtaining a posynomial or max-monomial expression for the electrical characteristics of integrated circuits that then can be used in a geometric program.

The use of posynomial and monomial expression for circuits and their solution with geometric programs is discussed in U.S. Pat. No. 6,269,277, entitled “System and Method for Designing Integrated Circuits,” and U.S. Pat. No. 6,311,145, entitled “Optimal Design of an Inductor and Inductor Circuit”, both assigned to the assignee of this application.

Some of the methodology described in the present application has been described in a co-pending application, specifically, “Saturation Region Transistor Modeling For Geometric Programming,” Ser. No. 09/475,733, filed Dec. 30, 1999.

### BRIEF DESCRIPTION OF THE DRAWINGS

FIG. 1 is a circuit diagram of an inverter. This circuit is used to describe the principles and in the present invention.

FIG. 2 is a table of design variables and performance metrics used to describe the operation of the circuit of FIG. 1.

FIG. 3 is a flow diagram illustrating various steps used in embodiments of the present invention.

FIG. 4 illustrates two additional steps used in an embodiment of the present invention.

FIG. 5 is a graph showing several functions and the errors that occur at the transition from one function to another.

### DETAILED DESCRIPTION OF THE INVENTION

A method for modeling the electrical characteristics of an integrated circuit is described. In the following description, a specific example concerning a CMOS inverter is described. It will be apparent that the present invention may be easily generalized to describe the electrical characteristic of any integrated circuit having transistors or other active or passive devices. Additionally well-known mathematical concepts have not been described in detail in order not to unnecessarily obscure the present invention.

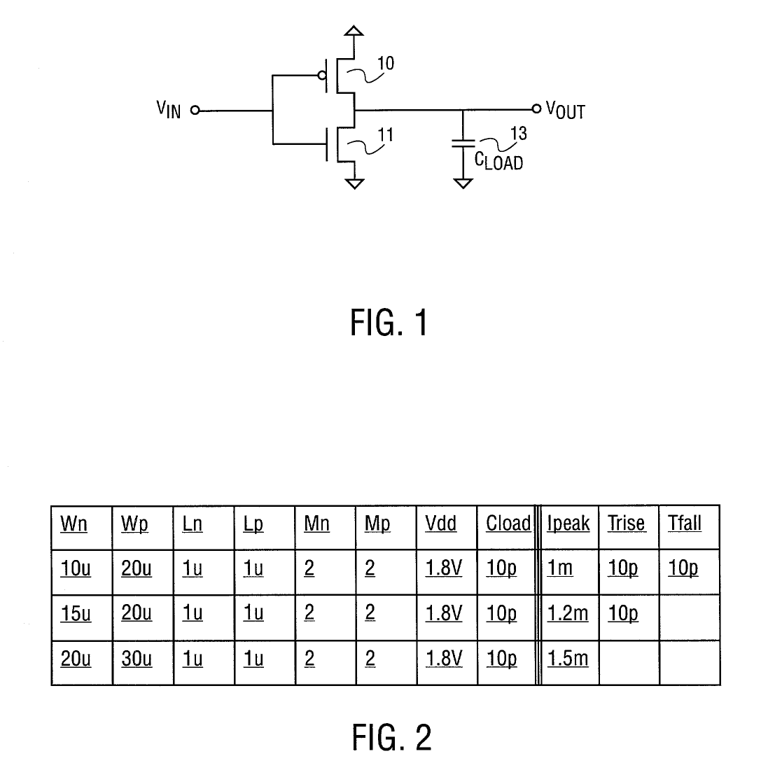

In FIG. 1 a typical MOS inverter is illustrated. It comprises a PMOS transistor 10 and an NMOS transistor 11 connected in series with a power supply (Vdd). The common terminal between the transistors 10 and 11 is coupled to a capacitor 13 used to represent output capacitance or load capacitance. The gates of the transistors 10 and 11 receive an input signal Vin.

The design variables defining the operation of the inventor of FIG. 1 are: the channel width of transistors 10 and 11 (Wn and Wp, respectively); the channel length of transistors 10 and 11 (Ln and Lp, respectively); the number of fingers in the gate of transistors 10 and 11 (Mn and Mp, respectively); the supply voltage (Vdd); and the load capacitance (Cload). (The number of fingers in the gate refers to the active part of the gate to which the source and drain regions are aligned. This is discussed in the application cited in the prior art section.)

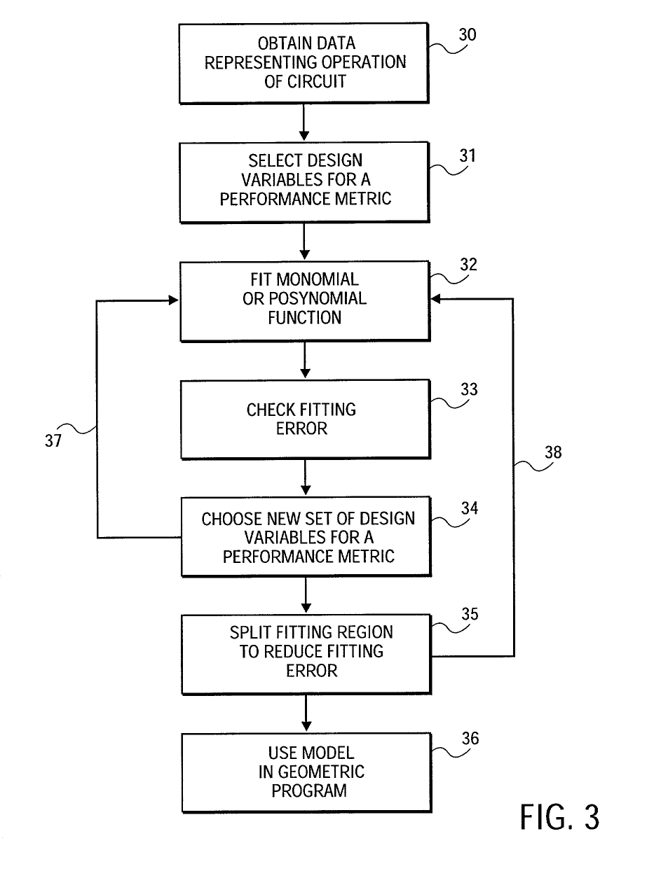

To begin, it is necessary to have data representing the operation of the circuit as shown by step 30 in FIG. 3. (Generally the log of the data is used as discussed in the prior art) A typical table is illustrated in FIG. 2 with eight design variables and three performance metrics, specifically, peak current, rise time and fall time. Additional performance metrics are possible. Note that there is no unique set of design variables. For example, the transistor active area M W L could have been chosen instead of M.

Data for the design variables and performance metrics can be provided by either actual measurements or from modeling such as with SPICE. Generally, as shown in FIG. 2, the variables, M, W and L are confined to a grid system and only dimensions falling on the grid system are used. Data is obtained over the region necessary for the range of interest. In other words, if Tᵣᵢₛₑ must be within 100 ps to 1 ns, only data points that give raise to such values of Tᵣᵢₛₑ are entered. Similarly, if it is known that the model will only be used for C_{load} less than 10 pF, only data that corresponds to C_{load} less than 10 pF is entered.

In an integrated circuit, the performance metrics will of course, be a function of the specific process used to fabricate the circuit in addition to the variables, such as shown in FIG. 2. In one embodiment of the present invention, the data which is obtained in step 30 of FIG. 3, are those variables which are not process dependent. The process dependent variables are used in, for instance, the simulation that occurs with SPICE. This allows the present invention to be implemented in a somewhat process independent manner. From one standpoint, the variables that can be changed are, for example, those as shown in FIG. 2, and typically a circuit designer does not have the opportunity to change the variables in a particular process.

Assume a solution is sought for the performance metrics Tᵣᵢₛₑ for the inventor of FIG. 1. A design variable or combination of design variables is selected which highlights or substantially controls the selected operating parameter as shown by step 31 of FIG. 3. The initial choice of variables is based on some understanding of the behavior of the circuit.

The design variables that are selected can be selected on a trial and error basis, or as stated above, on an understanding of the circuit. By way of example, for the circuit of FIG. 1, if Tᵣᵢₛₑ is the performance metric, it is quite apparent that the capacitor 13 will play a major role in the rise time of the circuit since the capacitor must be charged. Additionally, it is apparent then, that the capacitor is charged through transistor 10, and consequently, particularly the width, of transistor 10 will be significant in the charging of the capacitor 13. It will also be equally apparent that, for instance, variations in V_{dd} will not have a major effect on Tᵣᵢₛₑ. Similarly, if T_{fall} is to be considered, again it will be apparent that the capacitor 13 and the current carrying capacity of transistor 11 will be critical design variables to consider.

The next step 32 of FIG. 3 is to model the performance metric as a monomial and/or posynomial function of the design variables or as a max-monomial function. Since the monomial function is, in effect, a subset of posynomial functions the use of the term posynomial also includes monomial for purposes of this application.

One method for fitting mononomial curves known in the prior art is discussed below.

Assume it is necessary to approximate a function f(x) by a monomial function \hat{f}(x),where x is a vector of n real positive variables.

$$\hat{f} ( x ) = β {x}_{1}^{{α}_{1}} {x}_{2}^{{α}_{2}} ⋯ {x}_{n}^{{α}_{n}} \qquad ( 3 )$$

where α₁, α₂, . . . , αₙ∈R and β∈R⁺ are the function parameters. At first sight, this may seem a complicated nonlinear problem. However, this fitting problem becomes a linear problem with a simple change of variables. First take the logarithm of both sides of equation (3) to obtain, log \hat{f}(x)=β+α₁ log x₁+α₂log x₂+ . . . +αₙlog xₙ.

Defining α₀=log β, this takes the form of

$$log \hat{f} ( x ) = [ 1 log {x}_{1} log {x}_{2 } … log {x}_{n} ] [ \begin{matrix}{α}_{0} \\ {α}_{1} \\ {α}_{2} \\ ⋮ \\ {α}_{4}\end{matrix} ] \qquad ( 4 )$$

which is a linear function of the new parameters y=(α₀, . . . , α₄).

If m sample points of f(x) are used the problem consists in finding a value y such that f≈\hat{f},

$$z = [ \begin{matrix}log {f}_{1} \\ ⋮ \\ log {f}_{m}\end{matrix} ] \approx [ \begin{matrix}log {\hat{f}}_{1} \\ ⋮ \\ log {\hat{f}}_{m}\end{matrix} ] = [ \begin{matrix}1 & log {x}_{11} & … & log {x}_{1 n} \\ ⋮ & ⋮ & ⋮ & ⋮ \\ 1 & log {x}_{1 m} & … & log {x}_{1 m}\end{matrix} ] [ \begin{matrix}{β}_{0} \\ {β}_{1} \\ {β}_{2} \\ {β}_{3} \\ {β}_{4}\end{matrix} ] = Ay . \qquad ( 5 )$$

To find an appropriate value for y, minimize the p-norm of the error.

minimize∥z−Ay∥ₚ.

Minimizing the p-norm of the error is a convex problem and can be readily solved. The error distribution depends on the norm chosen. A small p puts more weight on the small errors and a large p puts more weight on the large errors.

Now described are the details for minimizing the 2-norm and the ∞norm. To minimize 2-norm, solve a least-squares problem, i.e., take y=(A^{T}A)⁻¹A^{T}z, where A is the m×n matrix in the equation (5).

It is important to realize that this choice of y yields the best fit for log f(x) not for f(x). In other words, minimize ∥log f−log \hat{f}∥₂, instead of ∥log f−log \hat{f}∥₂ results. It is interesting to see how these two fitting criteria are related. Minimize,

$$J = {\sum }_{i = 1}^{m} {( log {\hat{f}}_{i} - log {f}_{i} )}^{2} = {\sum }_{i = 1}^{m} {( log ( {\hat{f}}_{i} / {f}_{i} ) )}^{2} .$$

For α near 1 log α≈α−1 is obtained. Assuming the fit is good (i.e., (i.e.,(\hat{f}ᵢfᵢ))≈1, one can approximate

$${J \approx {\sum }_{i = 1}^{m} ( {\hat{f}}_{i} / {f}_{i} ) - 1 )}^{2} = {\sum }_{i = 1}^{m} {( \frac{{\hat{f}}_{i} - {L}_{i}}{{f}_{i}} )}^{2} = {( 1 / 100 )}^{2} {\sum }_{i = 1}^{m} {e}_{i}^{2} ,$$

where eᵢ is the square of the percent error for the ith sample. In other words, if the fit is good, the criterion used is quite close to the sum of the squares of the percent errors.

One can also minimize ∥z−Ay∥∞, i.e.,

minimize maxᵢ|\hat{f}ᵢ−fᵢ|.

This minimization problem can be written as a linear program, minimize u such that

log fᵢ−(α₀+α₁ log x₁ᵢ+ . . . +αₙ log xₙᵢ)≦ui=1, . . . m, (6)

log fᵢ−(α₀+α₁ log x₁ᵢ+ . . . +αₙ log xₙᵢ)≧−ui=1, . . . ,m

Again, by solving (6), minimizing the maximum error occurs for the fit of log f(x) not for f(x),

J=maxᵢ|log \hat{f}ᵢ−log fᵢ|=maxᵢ|log \hat{f}ᵢ/fᵢ|.

By taking the same approximation as before (i.e., for α≈α−1, log α≈α−1), the following can be within,

$$J \approx {max}_{i} \vert {\hat{f}}_{i} / {f}_{i} - 1 \vert = {max}_{i} \vert \frac{{\hat{f}}_{i} - {L}_{i}}{{f}_{i}} \vert = ( 1 / 100 ) \vert {e}_{i} \vert .$$

If the fit is good, the criterion used is effective to minimize the maximum absolute percent error.

For a matrix of size 1,000,000×6, the linear problem is solved using MATLAB in approximately forty seconds real time on an ULTRA SPARC1 running at 170 MHz. The computation time scales linearly with the problem size, i.e., problem of size 2,000,000×6, takes around eighty seconds.

One method for fitting max-monomial curves is the following.

Assume it is necessary to approximate a function f(x) by a max-monomial function \hat{f}(x),where x is a vector of n real positive variables. A max-monomial function f(x) is defined as f(x)=max{gᵢ(x)} where gᵢ is a monomial function of x. Thus,

$$\hat{f} ( x ) = {max}_{\_i} \{ {β}_{i} {x}_{1}^{{α}_{1 , i}} {x}_{2}^{{a}_{2 , i}} ⋯ {x}_{n}^{{a}_{n , i}} \} \qquad ( 3 )$$

where α_{1,i},α_{2,i}, . . . ,α_{n,i}∈R and β∈R⁺ are the function parameters. This is equivalent to approximating the function log(f(x)) by a piecewise linear function

log(\hat{f}(x))=max_{_{—}}ᵢ{log(βᵢ)+α_{1,i} log(x₁)+α_{2,i} log(x₂)+ . . . +α_{n,i} log(xₙ)}

This method is discussed in detail in “Method for Providing Convex Piecewise-Linear Expression for Multiple Variable System,” application Ser. No. 09/475,734, filed Dec. 30, 1999.

Assume it is necessary to fit a function f(x) by a posynomial function \hat{f}(x), where x is a vector of n positive variables. The function posynomial function \hat{f}(x) has the general form:

$$\hat{f} ( x ) = {\sum }_{i = 1}^{m} {β}_{i} {x}_{1}^{{α}_{, i1}} {x}_{2}^{{a}_{2 , i}} ⋯ {x}_{n}^{{a}_{n , i}}$$

To find a function \hat{f}(x) posynomial of M monomial terms that describes function f(x), is started with a function \hat{f}₁(x) posynomial of 1 monomial term and solve the following general nonlinear optimization problem (minimize the p-norm of the error):

min∥f(x)−\hat{f}₁(x)□ₚ

This problem can be solved by using readily available nonlinear optimization packages such as ______.

Now the following optimization problem is solved:

min∥f(x)−\hat{f}₂(x)∥ₚ

where \hat{f}₂(x) is a posynomial of 2 monomial terms. The solution of the problem min∥f(x)−\hat{f}₁(x)∥ₚ is used to compute the starting point of the problem min∥f(x)−\hat{f}₂(x)∥ₚ. Empirically it has been observed that this increases the quality of the fit.

The above steps are repeated for \hat{f}₃(x), . . . , \hat{f}_{M}(x) either until M monomial terms are reached or until the fitting error from \hat{f}ₖ(x) to \hat{f}ₖ₊₁(x) does not improve considerably.

Once the max-monomial and/or posynomial approximations are found, the fitting error |f(x)−\hat{f}(x)| is computed. This is shown as step 33 in FIG. 33. If the error is too large for practical applications steps 32 and 33 are repeated with a different set of design variables until the error is considered acceptable as shown by line 37. IF the error is acceptable , steps 34 and 35 are skipped and the model is used in a geometric program.

If a single max-monomial or posynomial model is not satisfactory, one can create a piecewise max-monomial or posynomial model. To do this, the region of fitting is split. This is done based on some knowledge of the circuit behavior. For example, if no good model can be found for Tᵣᵢₛₑ from 100 ps to 1 ns, the desired range of the performance metric can be split into several regions. The split can be based on (1) values of the performance metrics (for example, Tᵣᵢₛₑ>500 ps); on (2) values of some of the design variables (for example,

$$\frac{{C}_{load}}{{W}_{n} {L}_{n}} \geq 1 )$$

or on a combination (for example,

$$\frac{{C}_{load}}{{T}_{rise} {W}_{n}} \geq 1 ) .$$

The choice of the “break points” is done through observation and heuristic. For example, assume for the model of Tᵣᵢₛₑ:

Tᵣᵢₛₑ=\hat{f}₁ for θ≧θ,

Tᵣᵢₛₑ=\hat{f}₂ for θ₁≦θ≦θ₂

Tᵣᵢₛₑ=\hat{f}₃ for θ₂≦θ≦θ₃

where θ is the splitting parameter and θ₁, and θ₂ are the break points.

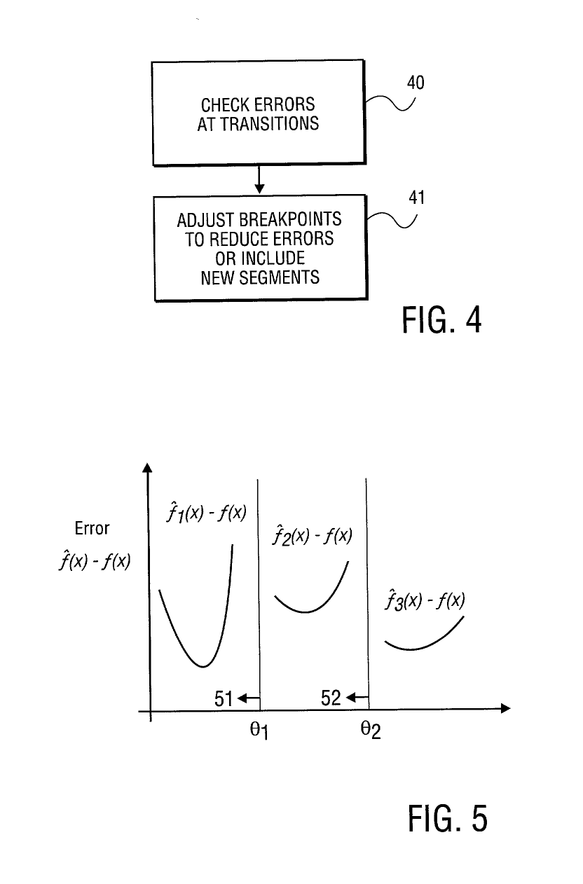

Once the performance metric such as Tᵣᵢₛₑ is defined in terms of the functions f₁,f₂ and f₃, it may be that at the transitions say between f₁ and f₂ or f₂ and f₃ a large amount of error exists. This is shown graphically in FIG. 5. At θ₁ (the value of θ selected for transitioning between a first function and a second function) the value for f₁ is found as well as the value for f₂. As shown in FIG. 5 there may be considerable error between the function f₁ at θ, and the function f₂ at θ₁. If the error (Tᵣᵢₛₑ−f₁) at θ₁ is relatively large compared to the error (Tᵣᵢₛₑ−f₂) at θ₁, moving θ₁ in the direction indicated by arrow 51 in FIG. 5 may minimize the error. Similarly it may occur that by examining error at θ₂, the error can be reduced by moving θ₂ in the direction indicated by arrow 52. Thus, the data segments can be redivided and if the error is high, say above some predetermined value, then the segments are adjusted so as to minimize the error and new monomial functions are fitted to the new data segments. Sometimes it is required to add new segments. This is shown by steps 40 and 41 in FIG. 4 (θ₁ is adjusted to θ₁¹ and θ₂ to θ₂¹).

When new segments are obtained new functions are fitted as shown by line 38. After step 41 is repeated the error is again checked as shown by step 42. If the error is within an acceptable level then steps 35 is skipped. The process of adjusting of the break points for the selected characteristic is repeated until the error is within an acceptable level. Note that for the example above θ is adjusted.

Finally as shown by step 36 of FIG. 3 the expression representing the performance metric is ready to be used in a geometric program.

Once the posynomial or max-monomial function is found, it then is used in an inequality and solved using geometric programming as taught in the prior art. For instance, once the function for Tᵣᵢₛₑ is known, it can be expressed in terms of an inequality to minimize substrate area or power, and then solved with geometric programming. The same would be true, for instance, where a function is developed for an oscillator circuit and an inequality sought to minimize jitter. The resultant solution is used to fabricate an integrated circuit, for instance, having a particular rise time with a minimum of substrate area.

As mentioned, a max-monomial function f(x) defined as

\hat{f}(x)=max{ĝₖ(x)} k=1, . . . , p

where g(x)ᵢ are monomials.

Max-monomial functions can be used in geometric programs as the objective function and/or as constraints.

Assume a max-monomial is used as the objective in an optimization problem with posynomial inequalities and monomial equalities. The optimization problem would have the following form,

max \hat{f}(x)

fᵢ(x)≦1 =1, , . . . , n

gⱼ(x)=1 j=1, . . . , m

x>0

where \hat{f}(x) is a max-monomial function as described above, fᵢ(x) are posynomial functions, and gᵢ(x) are monomial functions. This problem can be expressed as,

max t

ĝₖ(x)≦tk=1, . . . , p

fᵢ(x)≦1 i=1, . . . , n

gⱼ(x)=1 j=1, . . . , m

x<0

where t is a new design variable. This is equivalent to,

max f*(x)

gₖ*(x)≦1 k=1, . . . , p

fⱼ(x)<1 i=1, . . . , n

gⱼ(x)=1 j=1, . . . , m

x>0

The problem above fits the general form of a geometric program since f*(x) is a monomial (and therefore posynomial) function and gₖ*(x)=ĝₖ(x)/t are monomial (and therefore posynomial) functions. The general form of a geometric program is described in the prior art. Assume now that a max-monomial is used as constraint in an optimization problem with posynomial inequalities, monomial equalities and a posynomial objective. The optimization problem would have the following form,

max fₒ(x)

\hat{f}(ti x)≦1

fᵢ(x)≦1=1, , . . . , n

gⱼ(x)=1 j=1, . . . , m

x>0

where \hat{f}(x) is a max-monomial function as described above, fᵢ(x) are posynomial functions, and gᵢ(x) are monomial functions. This problem can be expressed as,

max fₒ(x)

ĝₖ*(x)≦t k=1, . . . , p

fᵢ(x)≦1 i=1, . . . , n

gⱼ(x)=1 j=1, . . . , m

x<0

where t is a new design variable. This is equivalent to,

max fₒ(x)

gₖ*(x)≦1 k=1, . . . , p

fᵢ(x)≦1 i=1, . . . , n

gⱼ(x)=1 j=1, . . . , m

x>0

The problem above fits the general form of a geometric program since

$${g}_{k}^{*} ( x ) = \frac{{\hat{g}}_{k} ( x )}{t}$$

are monomial (and therefore posynomial) functions. A problem that combines several max-monomial functions in the objective and constraints can also be readily converted into a geometric program by the introduction of additional design variables.

Thus a method for representing the behavior of an integrated circuit has been disclosed which lends itself to a model that can be used to formulate circuit design problems as geometric programs.

We claim:

1. A method for representing the operation of an integrated circuit as a posynomial or max-monomial expression comprising:
providing data for a plurality of design variables for the operation of at least one performance metric for the integrated circuit;
selecting from the plurality of variables at least one variable which influences the performance metric;
fitting a posynomial or max-monomial function to at least a part of the data containing the selected variables; and
checking error occurring between the data and the function.

2. The method defined by claim 1, including selecting of different variables if the error is greater than a predetermined error.

3. The method defined by claim 1 or 2, including breaking the performance metric into a plurality of ranges and providing separate posynomial or max-monomial expressions for each of the ranges.

4. The method defined by claim 3, including checking the error occurring at the transition from one range to the next.

5. The method defined by claim 4, wherein the log of the data is used.

6. The method defined by claim 1, wherein more than a single function is used if the error is larger than a predetermined amount.
